(19) United States
(12) Patent Application Publication
(10) Pub. No.: US 2004/0260848 A1
(43) Pub. Date: Dec. 23, 2004

(54) Method and system for controlling two peripheral devices connected to a personal computer throught the same PS/2 port

(75) Inventor: Gal Ben-David, Adi (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: SMARTEC SUBSIDIARY Ltd.

(21) Appl. No.: 10/893,939

(22) Filed: Jul. 20, 2004

Related U.S. Application Data
(63) Continuation-in-part of application No. 10/061,314, filed on Feb. 4, 2002.
(60) Provisional application No. 60/284,516, filed on Apr. 19, 2001.

(51) Int. Cl. G06F 13/14

(52) U.S. Cl. 710/62

(57) ABSTRACT

A system for controlling exchange of information between a personal computer (PC) and two peripheral devices coupled to the PC through a single common PS/2 port of the PC comprising: a computer mouse having a standard functionality and including radio enabling components coupled to the single common PS/2 port, an enhanced mouse driver incorporated in the PC and operative to perform an enhanced protocol that facilitates bidirectional exchanges of information between the radio enabling components and the PC while maintaining said standard functionality of said computer mouse, and an enhanced microcontroller incorporated in the computer mouse and operative to control the bidirectional exchanges of information through the enhanced protocol.

### CROSS REFERENCE TO RELATED APPLICATIONS

The present application is a continuation in part of U.S. patent application Ser. No. 10/061,314 filed Feb. 4, 2002, which claims the benefit of priority from U.S. Provisional Application No. 60/284,516, filed Apr. 19, 2001, the contents of which are incorporated herein by reference.

### FIELD AND BACKGROUND OF THE INVENTION

The PS/2 mouse and keyboard were introduced by IBM together with its PS/2 computer family, around 1987. Prior to this, the XT and AT models and almost all clones used the larger full-size 5-pin DIN keyboard connector. The PS/2 line also introduced the PS/2 mouse. Prior to this, almost all mice were either plugged into a standard serial port, or they were plugged into their own controller card, like the Microsoft Bus Mouse. The PS/2 mouse is currently the industry standard and is one of the main input displacement detectors in the Microsoft Windows environment. Therefore it may be assumed that almost all home and office personal computer (PC) systems have two PS/2 connectors, one for the keyboard and one for the mouse.

Most modern PCs are shipped with a sound card and speakers as a standard feature. The use of the sound card is currently limited to games and a few system alerts. On the other hand, a very small number of computer systems include a radio receiver. A radio receiver is one of the everyday devices used for information and entertainment. Since the radio is not a part of the standard computer, it is sold as an add-on. In order to use the computer user interface for radio control, the radio must be connected to the motherboard as an extension card, or by using one of the external ports. An extension card has a number of major drawbacks: it forces the end-user to open the computer, and it occupies one of a limited number of PCI or ISA slots. Using a dedicated computer port (Serial Port, Printer Port, USB port, etc.) for the sole purpose of radio may be problematic, because of the limited number of ports that exist, and because some may be needed for other peripherals (keyboard, printer, scanner, digital camera, etc.).

The development of mouse and graphical user interfaces started at Xerox Corp, and was further developed by Apple Computer. The PS/2 mouse subsystem has the following parts: motion sensors and switches, mouse controller, PS/2 communication link, keyboard/mouse controller, mouse driver and a Windows application that acts following mouse movements and buttons. The motion sensors (typically opto-mechanical) sense the mouse movement, and button switches sense the button states. The mouse controller reads the state of those sensors and tracks the present mouse position. When this information changes, the mouse controller sends a packet of data to the computer data interface controller. The packet transmission rate is limited by a parameter defined by the mouse and by the Windows (or other) operating system (around 100-200 packets a second). The mouse driver in the computer receives that data packet, decodes the information from it, and moves the cursor based on the information. Typically, the mouse driver has the information of the present mouse state (position and button states), and it informs the application or operating system on a timely basis. Typically the mouse drive calls mouse cursor moving routines when the mouse is moved, and sends messages to the software when the buttons are pressed.

In a typical modern PC mouse driver, the actual cursor movement is not linearly related to the mouse movement. During the pioneering research done at Xerox and Apple Computer in the development of the graphical user interface (GUI), it became apparent that no particular ratio between mouse movement and cursor movement was best suited for all tasks. Early work detected that there are two basic movements in the use of pointing devices: move a cursor to a desired area, and then move it exactly to a desired target. Those two movements have contradictory requirements, so Apple Computer solved the problem by monitoring the mouse movements and by changing its CPI (counts per inch) characteristics. When the mouse is moved slowly, it remains 100 CPI, and when the mouse is moved fast, it behaves as a 400 CPI mouse.

The PS/2 mouse is connected to the computer motherboard using the same type of 6-pin connector as the PS/2 keyboard. The data is sent using a synchronous serial protocol similar to the protocol used by the PS/2 keyboard. The mouse data is handled using a keyboard controller. The PS/2 type mouse is becoming more and more common because most new computers have an integrated PS/2 mouse port and are using a PS/2 mouse connected to that port (which also frees one serial port for other uses).

A computer peripheral radio receiver is disclosed in U.S. Pat. No. 6,289,206 to Chiang (hereafter Chiang '206). In Chiang's disclosure, an input displacement detector (3) (mouse, hand writing board, keyboard, etc) is connected to a sound receiving circuit (1) that includes radio receiver components through a micro-controller (18) included in the sound receiving circuit. The mouse (through the micro-controller) and the sound receiving circuit communicate through a computer peripheral input equipment (2) with a PC. The main task performed by the mouse is to analyze the times of operation of displacement concerning the computer peripheral input equipment (2) including key displacement and hand writing displacement etc, and to send the results to the microcontroller (18) for communication with the PC. The radio receiver is separate from the mouse, which appears to be a standard mouse.

In view of the existing problems and disadvantages listed above, there is a need for, and it would be highly advantageous to have, a method and system in which two peripherals are connected to, and controlled through, the same PS/2 port of a PC. For example, it would be advantageous to have a simple and inexpensive computer mouse that includes a radio or radio functions (the mouse and the radio being the two peripherals above) that can be easily hooked up to a computer using a single, regular PS/2 external port and the audio line-in, and operated in both radio and regular mouse modes by a single protocol.

### SUMMARY OF THE INVENTION

The present invention discloses a system and method for controlling two different peripheral devices (e.g. a mouse or keyboard and a radio) connected to a PC through a single, common PS/2 port. The invention further discloses a protocol that allows combined bidirectional exchange of information between the two peripherals and the PC through the common PS/2 port. Specifically and exemplarily, in a preferred embodiment system, the two different peripheral devices are a computer input displacement detector (preferably a mouse) and a wireless radio receiver (or simply “radio”). In one embodiment, the radio is most advantageously incorporated in the computer mouse, essentially forming an enhanced mouse having both standard mouse functionality and radio functionality. In another embodiment, the mouse and radio are physically separate entities.

An exemplary system according to the present invention includes both software and hardware. The hardware is the input displacement detector (as mentioned preferably a mouse, or alternatively a trackball or keyboard) that includes components necessary for receipt of wireless radio-frequency transmissions and a micro-controller. In particular, the input displacement detector is configured to receive FM/AM radio transmissions. The software is a computer program installed and operable on the computer to which the input displacement detector is connected. The function of the software is to control and to operate the wireless radio-frequency receiver including, but not limited to, frequency (channel) selection, recording parameters, and so forth.

The received wireless radio-frequency audio transmissions are made audible through devices known in the art (for example, a sound card and speakers) installed in the computer. Use of the device allows reception and display (auditing) of wireless radio-frequency signals on a PC without the need to purchase and install components inside the PC. Installation of the system of the present invention requires only the simple attachment of the input displacement detector through the standard input displacement detector ports, specifically a PS/2 port and an Audio-In port. The invention thus obviates the need for an internal radio card or an Internet connection.

According to the present invention there is provided a method for controlling two peripheral devices connected to a PC through a single common PS/2 port, comprising the steps of: connecting a first peripheral device characterized having a standard functionality to a PS/2 port of the PC; connecting a second peripheral device to the same PS/2 port of the PC; and performing a protocol that facilitates bidirectional exchange of information between the second peripheral device and the PC while maintaining the standard functionality of the first peripheral device, whereby the method allows simultaneous use of the same PS/2 port for information exchanges between the PC and the two peripheral devices, and whereby the two peripheral devices also communicate with each other.

According to the present invention there is provided a method for exchanging information between two peripheral devices connected simultaneously to the same PS/2 port of a PC and the PC, comprising the steps of: rendering the PC operative to perform bidirectional information exchanges between a first of the two peripheral devices and the PC; and performing a protocol that facilitates the bidirectional information exchanges, while maintaining unchanged a standard functionality of a second of the two peripheral devices, whereby the two peripheral devices also communicate with each other.

According to the present invention there is provided a system for controlling exchange of information between two peripheral devices and a PC that has at least one PS/2 port, the peripheral devices connected to the PC through a single common PS/2 port, the system comprising: a first peripheral device having a standard functionality and coupled to the at least one PS/2 port; a second peripheral device coupled to the first peripheral device and to the same PS/2 port that serves thereby as the common PS/2 port; and a protocol performing subsystem operative to facilitate bidirectional exchanges of information between the second peripheral device and the PC through the common PS/2 port while maintaining the standard functionality of the first peripheral device, whereby the system is operative to provide simultaneous use of the same the PS/2 port for information exchange between the PC and the two peripheral devices.

According to one feature in the system for controlling exchange of information between two peripheral devices and a PC of the present invention, the first peripheral device is a computer mouse and the second peripheral device is a wireless radio receiver.

According to another feature in in the system for controlling exchange of information between two peripheral devices and a PC of the present invention, the wireless radio receiver is integrated in the computer mouse.

According to the present invention there is provided a system for controlling exchange of information between a PC and two peripheral devices coupled to the PC through a single common PS/2 port of the PC, the system comprising: a computer mouse having a standard functionality and including radio enabling components, the computer mouse coupled to the single common PS/2 port; an enhanced mouse driver incorporated in the PC and operative to perform an enhanced protocol that facilitates bidirectional exchanges of information between the radio enabling components and the PC while maintaining the standard functionality of the computer mouse; and an enhanced microcontroller incorporated in the computer mouse and operative to control the bidirectional exchanges of information through the protocol.

### BRIEF DESCRIPTION OF THE DRAWINGS

The invention is herein described, by way of example only, with reference to the accompanying drawings, wherein:

FIG. 1 is a schematic description of an embodiment of the Radio-Mouse system of the present invention in which radio components are integrated into a computer input displacement detector;

FIG. 2 is a schematic description of a second embodiment of the system of Radio-Mouse system of the present invention in which a radio receiver is physically separate from a computer input displacement detector;

FIG. 3 is a schematic block-diagram of a preferred embodiment of the Mouse-Radio system.

### DESCRIPTION OF THE PREFERRED EMBODIMENTS

The present invention discloses a system and method for controlling two different peripheral devices (e.g. a mouse and a radio) connected to a PC through a single, common PS/2 port. The invention further discloses a protocol that allows combined bidirectional exchange of information between the two peripherals and the PC through the common PS/2 port. In a preferred embodiment, the system includes a input displacement detector operative to receive FM/AM radio transmissions. The input displacement detector is preferably a computer mouse with otherwise standard functionality, a trackball or a keyboard. All computer input displacement detectors that may be used in the present invention will be referred to henceforth as “mouse”. The mouse, which may communicate with the PC by wire or wirelessly, has a standard functionality similar to that of a Microsoft Intellimouse or similar device, but with an added functionality of a radio receiver. The preferred embodiment system is referred to hereafter in a general way as a “Radio-Mouse” system, or in short a “Radio-Mouse”. The Radio-Mouse includes software and hardware. The function of the software is to control and to operate the wireless radio-frequency receiver including, but not limited to, frequency (channel) selection, recording parameters, etc. In terms of hardware, it is well known that a wireless radio-frequency receiver is made up of a number of components, including a receiver, an amplifier, a frequency filter, and an antenna.

The principles and operation of a Radio-Mouse system according to the present invention may be better understood with reference to the drawings and the accompanying description.

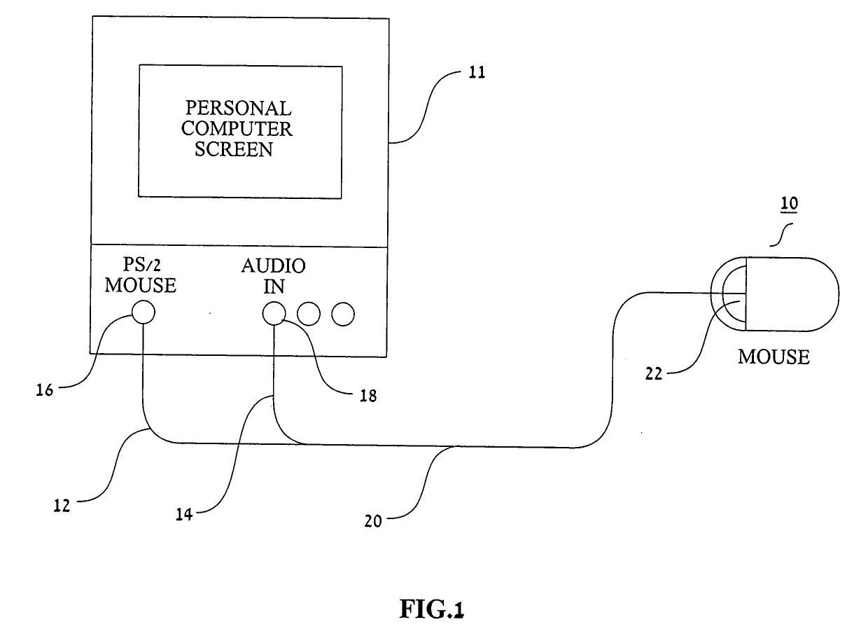

Referring now to the drawings, FIG. 1 shows a schematic description of one preferred embodiment of the system of the present invention in which both standard mouse components and radio components are integrated in an input displacement detector (mouse) 10. Device 10 thus represents the hardware part of an “integrated Radio-Mouse” that combines two different peripheral devices, a mouse and a radio. Device 10 can act like any other PC input displacement detector of its type (e.g. like a regular, standard mouse) known in the art. When device 10 is used as a regular mouse, it performs its mouse functions in the usual, standard way. In addition, for the function of wireless radio-frequency reception, device 10 includes radio components that are necessary for wireless radio-frequency reception. These components include for example a receiver, an antenna, an amplifier, a frequency filter, or any other radio component required for the normal operation of a wireless radio receiver as known in the art, and are collectively referred to herein as “radio enabling components”. Device 10 is connected to a personal computer 11 by two, preferably wired, first and second connections (communication links) 12 and 14, as follows: first connection 12 connects device 10 preferably to a PS/2 port 16 to allow two-way transfer of commands. Second connection 14 connects device 10 preferably to an Audio IN port 18 of a sound card of the computer. Note that first connection 12 serves as a single common PS/2 connection to PS/2 port 16 for the two peripheral hardware components (radio and mouse) included in device 10. Alternatively, device 10 may communicate with the PC wirelessly, e.g. by radio frequency or optical signals. The two-way information exchange between device 10 and PC 11 through single common PS/2 port 16 is inventively facilitated by a protocol described in detail below. Such an exchange between two different peripherals and a PC through a single PS/2 port is unknown in prior art, probably due to the fact that the standard prior art configuration of a PS/2 port and the relevant protocol do not allow such an exchange.

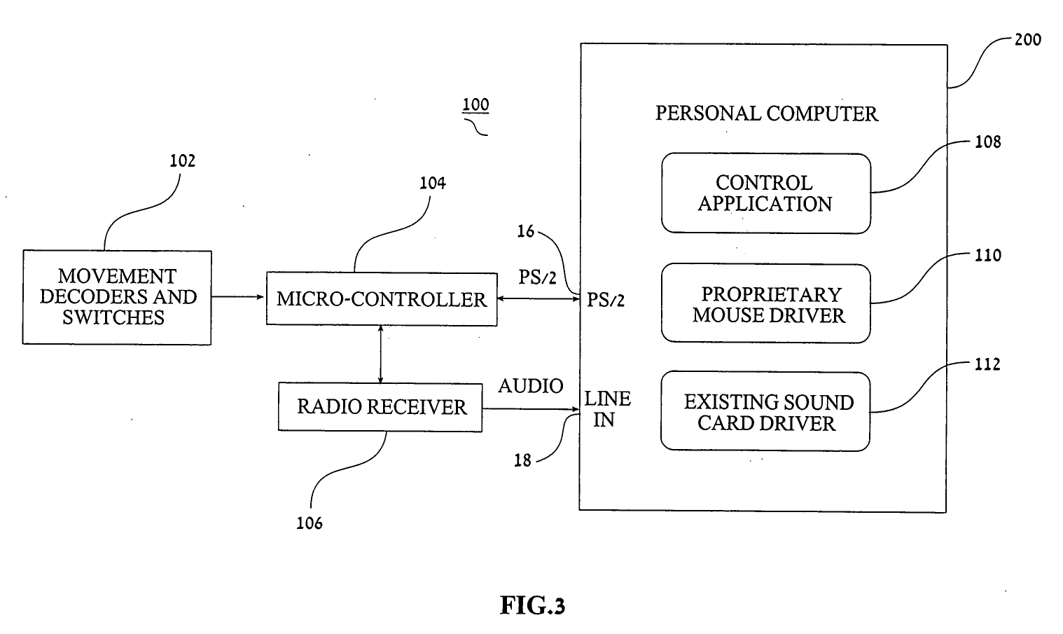

Connections 12 and 14 are preferably united into a single physical conduit 20 at an output port 22 of device 10. The configuration of connections 12 and 14 united into a single physical conduit 20 represents a Y connecting configuration. Received signals can be processed and made audible through computer speakers (not shown) that are connected to the computer in the usual way. The combined radio functions and normal mouse controls are controlled by an enhanced microcontroller, as described in FIG. 3 below, via an inventive enhanced protocol, which is described in detail below.

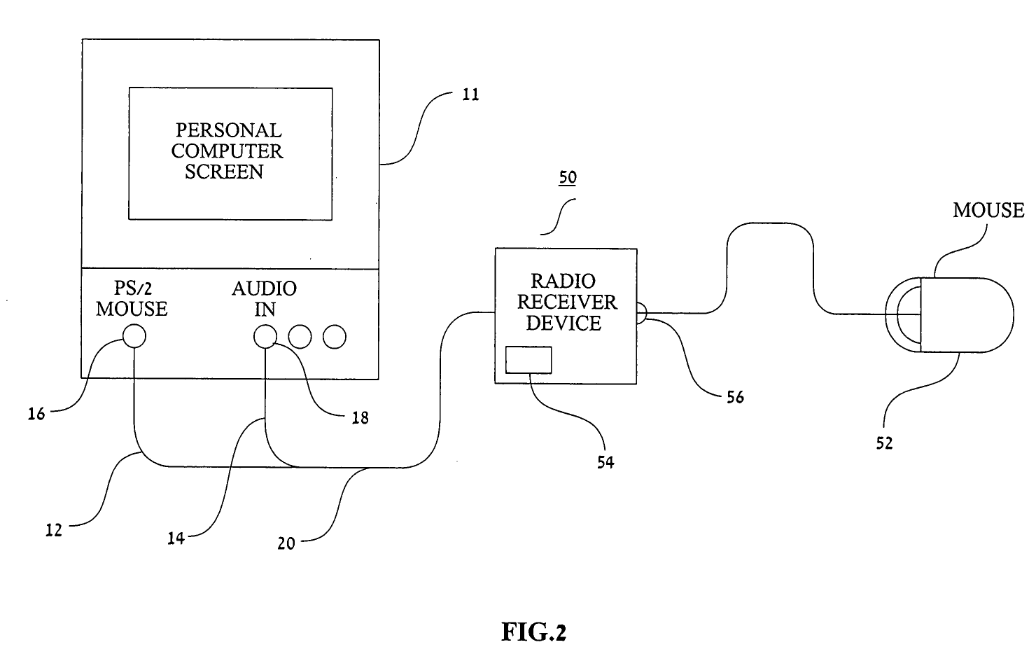

FIG. 2 shows a schematic description of another preferred embodiment of the Radio-Mouse system of the present invention, in which a wireless radio frequency receiver 50 is physically separate from a computer input displacement detector (e.g. mouse, keyboard or trackball) 52. In this embodiment, device 50 represents the hardware part of a “non-integrated Radio-Mouse”. Similarly to device 10 of FIG. 1, device 50 is comprised of known and widely available components necessary for wireless radio-frequency reception including a receiver, an antenna, an amplifier, a frequency filter, etc. (not shown), and is connected to computer 11 preferably through the same Y connecting configuration. In addition, device 50 includes an enhanced microcontroller 54, located preferably inside device 50, and an input port 56 to which computer input displacement detector 52 can be attached. In addition to acting as a wireless radio frequency receiver, as described in more detail below, device 50 is also configured to relay two-way commands between computer input displacement detector 52 and the computer. Microcontroller 54 controls the radio function while rendering transparent the mouse communication.

As described above, the hardware part of the Mouse-Radio system of the present invention is preferably connected to the personal computer using the standard PS/2 interface and an analog audio interface. As shown, a single conduit splitting into two connectors connected to two PC ports connects the mouse to the rear side of the computer.

FIG. 3 is a schematic block-diagram of a preferred embodiment of a Mouse-Radio system 100 according to the present invention. As stated above, Mouse-Radio system 100 includes a number of hardware and software components, shown as blocks in the block diagram. In common with the regular PS/2 mouse subsystem, these components include a movement (motion) sensors and switches block 102, as well as other well-known mouse subsystem parts (not shown), such as a mouse controller, a PS/2 communication link, a keyboard/mouse controller and a mouse driver. In addition, Mouse-Radio system 100 includes an enhanced microcontroller block 104, and a radio-receiver 106, as well as three software modules used for control and normally residing inside a personal computer 200: a Windows control application module 108 (or another device driver that is operating system oriented), a special (in the sense of not being the normal Microsoft) mouse driver 110, and an existing sound card driver 112. Enhanced microcontroller 104 and mouse driver 110 form together a protocol performing subsystem that facilitates the performance of an enhanced protocol described in detail below. Microcontroller 104 handles three parallel tasks. It decodes the information from movement decoders and switches 102, manages the PS/2 interface and controls the digital I/O of radio receiver 106. Thus, microcontroller 104 provides an enhanced functionality over that of a normal mouse controller that is embedded in the mouse. Normal mouse controller functions, as well as the PS/2 pinout and line protocols are well known. More information regarding normal mouse controller functions may be found by reading off-the-shelf mouse controller manuals, datasheets, and application notes, for example for the GL310MC3D5B-PS/2 3D5B Mouse controller from Genesys Logic, Inc. 10F, No. 11, Ln. 3, Tsao Ti Wei, Shenkeng, Taipei, Taiwan, or for the TEA5757-AM/FM Digitally controlled radio, from Phillips Semiconductors, International Marketing & Sales Communications, Building BE-p, P.O. Box 218,5600 MD EINDHOVEN, The Netherlands.

Special mouse driver 110 enables the control of the radio functionalities together with normal mouse activity. Control application 108 controls the radio using mouse driver 110, and also interfaces with existing sound card driver 112 for volume adjustment and similar tasks.

As should be clear to one skilled in the art, some of the components, such as the frequency filter, may be implemented as software instead of hardware. In some cases the amplifier may not be necessary.

The software acts as a control system of the receiver and replaces the buttons and other controls found in prior-art wireless radio-frequency receivers. Other functions such as recording and preprogramming are easily implemented by components already found in the computer.

Operation

The Mouse-Radio system is designed to use the single, common PS/2 mouse interface for radio control in a way that will not interfere with normal mouse operation, for example by allowing control of the radio without phenomena such as mouse cursor jumps or freezes. This special and innovative function of dual control of two peripherals through a single common PS/2 interface is facilitated by special mouse driver 110. When an application is started, mouse driver 110 checks if the mouse function as a radio is in use. If the mouse is not in use as a radio, mouse driver 110 resumes its function as a normal mouse driver, and the application gets some error code. If the mouse is in use as a radio, the driver enables the application to send commands to, and get status reports from the radio circuit.

As mentioned, the present invention discloses an enhanced protocol that allows combined bidirectional exchange of information between the two peripherals and the PC through the common PS/2 port. This enhanced protocol includes protocol multiplexing sections of “Radio Command”, “Radio Status” and “Verifying the existence of the Radio-Mouse”, which are described in detail below. Specific Radio Commands include “Set radio frequency”, “Scan up”, and “Scan down”. Specific “Radio Status” items include “Is Radio scanning”, “Get Radio frequency” and “Is stereo”. The main inventive feature in using a single, enhanced protocol for both mouse and radio features involves sending short radio control and status commands or signals while the mouse is in a HOLD communication state. When in a HOLD communication state, mouse microcontroller 104 keeps track of the mouse movements and stores them until the HOLD communication is deactivated. In a typical case, driver 110 sends a STOP command to the mouse, then communicates with the radio and returns the mouse to normal operation by sending a GO command.

As mentioned, microcontroller 104 enhances the functionality of a normal mouse controller by adding to the normal mouse features a radio receiver interface. As a mouse controller, it decodes the information from the movement detectors and switches. This information is translated into XY relative movements (XY change in position since last packet transmission) and switches state. This information is typically sent as information packets (3-5 bytes) to the computer.

A first important feature of a regular PS/2 mouse used by the Radio-Mouse is the accumulation of movement information for a few milliseconds while the PS/2 serial protocol is used to transfer radio commands and status. Stopping the mouse from using the PS/2 interface is done by using MOUSE-DISABLE (PS/2 Mouse command 0xF5 (hexadecimal notation)) and MOUSE-ENABLE (Mouse command 0xF4) commands. This feature of stopping the mouse from sending information exists in the normal PS/2 mouse, but is rarely used. One should note that no mouse movement data is lost, since the movements are accumulated and are sent in the information packet following the MOUSE-ENABLE command.

A second important feature of the normal PS/2 mouse is the limited number of legal computer to mouse commands. Mouse commands are always in the range 0xE0-0xFF. Sending commands from the computer to the mouse in the range 0x00-0xDF will not be identified by normal mouse, and the mouse will reply with a RESEND status byte (mouse status byte 0xFE).

A third regular PS/2 mouse feature that is used by the Radio-Mouse is the MOUSE GET ID (0xF2) command. This feature is used to check the mouse type among: Basic 2-buttons, 3-buttons+wheel Microsoft IntelliMouse and 5-buttons wheel Microsoft IntelliMouse. After reset, all mouse types return ID=0. Windows then tries to upgrade the interface by sending a series of SET SAMPLING RATE (0xF3) commands. For example, sending the following series of commands:

1. SET SAMPLING RATE=200 (0xF3, 0xC8)

2. SET SAMPLING RATE=100 (0xF3, 0x64)

3. SET SAMPLING RATE=80 (0xF3, 0x50) upgrades the mouse interface from Basic 2 button to IntelliMouse 3—buttons. After sending the above series of commands, Windows checks for mouse ID. The Basic mouse will return ID=0x00, while the IntelliMouse 3—buttons will return ID=0x03.

Digital Radio Tuner Circuit

Off-the-shelf radio tuner integrated circuits and chipsets exist and can be easily obtained. One may easily build a radio using the manufacturer application notes and design examples. In both preferred embodiments of the present invention, one can use a digitally controlled radio integrated circuit, for example (IC) TEA5757 from Phillips. Similar circuits are available from other manufacturers. The TEA5757 is controlled by the microcontroller using a serial interface. It is important to notice that the chip status may be read by serially reading 25 bits by the microcontroller, removing the dummy bit (bit 15) and sending 3 bytes to the host computer. A command to the chip may be done by sending three bytes from the host to the microcontroller. The microcontroller then adds the dummy bit and writes the whole 25 bits command to radio IC TEA5757. The radio chip acts as an autonomous entity, and its communication with the host is needed only when the user requires a new frequency (station). After sending a command for frequency set or scan, the driver waits for the radio to confirm new settings. From here on, until a next change is needed, no further attention is needed.

PS/2 Host Controller and Driver Operation

The interface between the main CPU of the PC and the keyboard/mouse is controlled by a dedicated microcontroller located on the motherboard. The details of the microcontroller and its connections may be found in PC hardware literature. For the present discussion only two I/O ports, 0x60 and 0x64 need some explanation. In order to send a command to the mouse, the software driver should write the byte 0xD4 to port number 0x64, and then write the mouse command (for example 0xF4 that was explained before) to port 0x60. Mouse response may then be found in port 0x60.

The enhanced protocol of the present invention is described next in more detail.

Radio Protocol Multiplexing—Radio Command

As mentioned above, sending a command to the mouse requires a mouse command that is not in the range 0xE0-0xFF. In order to send a three-byte mouse command we use the mouse command 0x80 followed by three bytes. This is typically done using the following protocol:

| Direction | Command | Remarks |
|---|---|---|
| Computer -> Mouse | 0xF5 | Mouse disable |
| Computer <- Mouse | 0xFA | Confirm |
| Computer -> Mouse | 0x80 | Special radio command |
| Computer <- Mouse | 0xFA | Confirm |
| Computer -> Mouse | 0x?? | Command byte 1 |
| Computer <- Mouse | 0xFA | Confirm |
| Computer -> Mouse | 0x?? | Command byte 2 |
| Computer <- Mouse | 0xFA | Confirm |
| Computer -> Mouse | 0x?? | Command byte 3 |
| Computer <- Mouse | 0xFA | Confirm |
| Computer -> Mouse | 0xF4 | Mouse enable |
| Computer <- Mouse | 0xFA | Confirm |

Radio protocol Multiplexing—Radio Status

As mentioned earlier reading the radio status requires a mouse command that is not in the range 0xE0-0xFF. In order to read a three-byte mouse status we use the mouse command 0x81 and then read three bytes. This is typically done by the following protocol:

| Direction | Command | Remarks |
|---|---|---|
| Computer -> Mouse | 0xF5 | Mouse disable |
| Computer <- Mouse | 0xFA | Confirm |
| Computer -> Mouse | 0x81 | Special radio command |
| Computer <- Mouse | 0xFA | Confirm |
| Computer <- Mouse | 0x?? | Status byte 1 |
| Computer <- Mouse | 0x?? | Status byte 2 |
| Computer <- Mouse | 0x?? | Status byte 3 |
| Computer -> Mouse | 0xF4 | Mouse enable |
| Computer <- Mouse | 0xFA | Confirm |

Radio Protocol Multiplexing—Verifying the Existence of the Radio-Mouse

As mentioned earlier the driver should verify that a Radio-Mouse exists before sending non-standard mouse commands. This is typically done is a similar manner to the Microsoft upgrading protocol mentioned earlier, by sending sampling rate 0x80 three times, for example through the following protocol:

| Direction | Command | Remarks |
|---|---|---|
| Computer -> Mouse | 0xF3 | Mouse set rate |
| Computer <- Mouse | 0xFA | Confirm |
| Computer -> Mouse | 0x50 | Rate = 80 |
| Computer <- Mouse | 0xFA | Confirm |
| Computer -> Mouse | 0xF3 | Mouse set rate |
| Computer <- Mouse | 0xFA | Confirm |
| Computer -> Mouse | 0x50 | Rate = 80 |
| Computer <- Mouse | 0xFA | Confirm |
| Computer -> Mouse | 0xF3 | Mouse set rate |
| Computer <- Mouse | 0xFA | Confirm |
| Computer -> Mouse | 0x50 | Rate = 80 |
| Computer <- Mouse | 0xFA | Confirm |
| Computer -> Mouse | 0xF2 | Get device type (ID) |
| Computer <- Mouse | 0xFA | Confirm |
| Computer <- Mouse | 0x55 | Radio mouse (0, 3 or 4 for |
| | | normal mouse) |

Further Aspects of the Invention

Since the device controls are implemented as software installed on the computer, it is possible to use the device in a number of ways, as desired. For example: a) One can place customized display and control panels on the computer screen, dependent on specific user and design considerations; b) Programming of radio reception and recording can be easily performed. The user can decide to preprogram the receiver to turn on and off at specific times and dates for the purposes of listening or recording. Desired stations can be marked. Frequency scanning can be performed to find desired programming types or stations; c) The software can easily be upgraded or modified, or options can be added by connecting to the supplier of the present invention through the Internet. Programming scheduling can be accessed or downloaded through the Internet.

In summary, the present invention inventively discloses a system that combines the functions of a regular PC input displacement detector (such as a mouse) and a radio receiver, and which can exchange information bi-directionally with the PC through a single common PS/2 interface and port. The invention also discloses a method of use of this system, based on an enhanced protocol. The invention shows that advantageously, wireless radio-frequency reception and auditing on a personal computer is made possible by incorporating the radio enabling hardware components (preferably implemented as a simple and cheap printed circuit) into a computer input-device (such as a computer mouse), by providing an enhanced protocol and a special driver as well as other components including control software installed on the computer, and by using the sound card and speaker already installed on the computer.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. Although the example above refers specifically to FM radio reception, it is clear to one skilled in the art that using the teachings of the present invention and with suitable modification, reception of other frequencies and bands can be implemented.

What is claimed is:

1. A method for controlling two peripheral devices connected to a personal computer (PC) through a single common PS/2 port, comprising the steps of:
a. connecting a first peripheral device characterized by a standard functionality to a PS/2 port of the PC;
b. connecting a second peripheral device to the same said PS/2 port of the PC; and
c. performing a protocol that facilitates bidirectional exchange of information between said second peripheral device and the PC while maintaining said standard functionality of said first peripheral device,
whereby the method allows simultaneous use of the same said PS/2 port for information exchanges between the PC and the two peripheral devices.

2. The method of claim 1, wherein said step of connecting a first peripheral device includes connecting a computer input displacement detector to said PS/2 port, and wherein said step of connecting a second peripheral device includes connecting a wireless radio frequency receiver to the same said PS/2 port.

3. The method of claim 2, wherein said connecting a computer input displacement detector to said PS/2 port includes connecting a computer mouse to said PS/2 port.

4. The method of claim 3, wherein said step of performing a protocol that facilitates bidirectional exchange of information between said wireless radio frequency receiver and the PC while maintaining said standard functionality of said computer mouse is preceded by the steps of:
d. providing an enhanced mouse driver incorporated in the PC and operative to perform said protocol while maintaining said standard functionality of said computer mouse, and
e. providing an enhanced microcontroller incorporated in said computer mouse and operative to control both said peripheral devices as well as said bidirectional exchanges of information through said protocol.

5. The method of claim 4, wherein said step of performing said protocol further includes performing a radio multiplexing protocol.

6. The method of claim 5, wherein said performing a radio multiplexing protocol includes performing multiplexing operations selected from the group consisting of radio commands, radio status inputs and verification of the existence of said computer mouse.

7. The method of claim 3, wherein said steps of connecting said wireless radio frequency receiver and said computer mouse to the same said PS/2 port of the PC are preceded by the step of incorporating said wireless radio receiver in said computer mouse.

8. A method for exchanging information between two different peripheral devices connected simultaneously to the same PS/2 port of a personal computer (PC) and said PC, comprising the steps of:
a. rendering the PC operative to perform bidirectional information exchanges between a first of said two peripheral devices and said PC; and
b. performing a protocol that facilitates said bidirectional information exchanges, while maintaining unchanged a standard functionality of a second of said two peripheral devices.

9. The method of claim 8, wherein said first peripheral device includes a wireless radio frequency receiver, wherein said second peripheral device includes a computer mouse characterized by a standard functionality, and wherein said step of rendering the PC operative to perform bidirectional information exchanges includes:
i. providing an enhanced mouse driver incorporated in said PC and operative to perform said protocol while maintaining said standard computer mouse functionality, and
ii. providing an enhanced microcontroller incorporated in said computer mouse and operative to control both said peripheral devices as well as said bidirectional exchanges of information through said protocol.

10. A system for controlling exchange of information between two peripheral devices and a personal computer (PC) that has at least one PS/2 port, said peripheral devices connected to said PC through a single common said PS/2 port, the system comprising:
a. a first peripheral device having a standard functionality and coupled to said at least one PS/2 port;
b. a second peripheral device coupled to said first peripheral device and to the same said at least one PS/2 port that serves thereby as said common PS/2 port; and
c. a protocol performing subsystem operative to facilitate bidirectional exchanges of information between said second peripheral device and the PC through said common PS/2 port while maintaining said standard functionality of said first peripheral device,
whereby the system is operative to provide simultaneous use of the same said PS/2 port for information exchange between the PC and said two peripheral devices.

11. The system of claim 10, wherein said first peripheral device includes a computer input displacement detector and wherein said second peripheral device includes a wireless radio frequency receiver.

12. The system of claim 11, wherein said computer input displacement detector is selected from the group comprising a trackball and a computer keyboard.

13. The system of claim 11, wherein said computer input displacement detector includes a computer mouse.

14. The system of claim 11, wherein said protocol performing subsystem includes an enhanced mouse driver incorporated in said PC and operative to perform an enhanced protocol while maintaining said standard functionality of said computer mouse, and an enhanced microcontroller incorporated computer mouse and operative to control said bidirectional exchanges of information through said enhanced protocol.

15. The system of claim 14, wherein said enhanced protocol includes a radio multiplexing protocol operative to facilitate bidirectional exchanges of information between said a wireless radio frequency receiver and the PC through said common PS/2 port while maintaining said standard functionality of said computer mouse.

16. The system of claim 15, wherein said radio multiplexing protocol includes multiplexing operations selected from the group consisting of radio commands, radio status inputs and verification of the existence of said computer mouse.

17. The system of claim 13, wherein said wireless radio frequency receiver includes radio enabling components incorporated in said computer mouse.

18. A system for controlling exchange of information between a personal computer (PC) and two peripheral devices coupled to the PC through a single common PS/2 port of the PC, the system comprising:
a. a computer mouse having a standard functionality and including radio enabling components, said computer mouse coupled to the single common PS/2 port;
b. an enhanced mouse driver incorporated in said PC and operative to perform an enhanced protocol that facilitates bidirectional exchanges of information between said radio enabling components and said PC while maintaining said standard functionality of said computer mouse; and
c. an enhanced microcontroller incorporated in said computer mouse and operative to control said bidirectional exchanges of information through said enhanced protocol.

19. The system of claim 18, wherein said computer mouse coupling to said PC is by a wired connection.

20. The system of claim 18, wherein said computer mouse coupling to said PC is by a wireless connection.
